(19) United States
(12) Patent Application Publication
(10) Pub. No.: US 2025/0306999 A1
(43) Pub. Date: Oct. 2, 2025

(54) APPARATUSES, SYSTEMS, AND METHODS FOR SCHEDULING PROCESSOR OPERATIONS

(71) Applicant: Advanced Micro Devices, Inc., Santa Clara, CA (US)

(72) Inventors: Michael Estlick, Ft. Collins, CO (US); Erik Swanson, Ft. Collins, CO (US); Eric Dixon, Ft. Collins, CO (US)

(73) Assignee: Advanced Micro Devices, Inc., Santa Clara, CA (US)

(21) Appl. No.: 18/622,913

(22) Filed: Mar. 30, 2024

(51) Int. Cl. G06F 9/48

(52) U.S. Cl. CPC G06F 9/4893

(57) ABSTRACT

A disclosed system includes a physical processor with a scheduler circuit. The scheduler circuit can be configured to: (1) pre-pick, from a set of delayed broadcast scheduler entries, a pre-picked set of scheduler entries that have each met a threshold cycle time, (2) pick for execution, from a set of ready scheduler entries, a picked ready scheduler entry that has met a source dependence cycle time, the set of ready scheduler entries including (A) a set of scheduler entries that have each met the source dependence cycle time, and (B) the pre-picked set of scheduler entries, and (3) delay a broadcast of a scheduler update to the set of delayed broadcast scheduler entries.

### BACKGROUND

In microprocessor architecture, efficient instruction scheduling is paramount for high performance. Traditional schedulers manage the sequence and timing of operations but often grapple with the complexities of source dependencies and the fixed cycle time of execution. As processors manage increasingly intricate tasks, the limitations of conventional scheduling, particularly in accommodating the breadth of instructions and optimizing resource utilization, become more pronounced.

### BRIEF DESCRIPTION OF THE DRAWINGS

The accompanying drawings illustrate a number of examples and are a part of the specification. Together with the following description, these drawings demonstrate and explain various principles of the instant disclosure.

FIG. 1 depicts a block diagram of a processing system in accordance with some implementations, examples, and/or variations of the present disclosure.

FIG. 2 shows a block diagram of an example physical processor in accordance with some implementations, examples, and/or variations of the present disclosure.

FIG. 3 illustrates a block diagram of an example processing core in accordance with some implementations, examples, and/or variations of the present disclosure.

FIG. 4 shows a block diagram of an example scheduler circuit in accordance with some implementations, examples, and/or variations of the present disclosure.

FIG. 5 presents an operational flow block diagram of a scheduler circuit that incorporates various tables representing buffers, queues, and designations that may be included in a processing pipeline in accordance with some implementations, examples, and/or variations of the present disclosure.

FIG. 6 depicts a flow diagram for a method for scheduling processor operations in accordance with some implementations, examples, and/or variations of the present disclosure.

FIG. 7 is a state transition diagram that illustrates how scheduler entries may transition through various components of a scheduler circuit over multiple cycles.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the instant disclosure covers all modifications, equivalents, and alternatives falling within the scope of the appended claims.

### DETAILED DESCRIPTION OF EXAMPLE IMPLEMENTATIONS

The present disclosure generally pertains to the field of microprocessor architecture and, more specifically, to improved apparatuses, systems, and methods for managing scheduling entries within an instruction scheduler. Microprocessors can operate with a scheduler that orchestrates the timing and order of instruction execution. This can be a critical function that directly influences computational efficiency and performance. Traditional schedulers, such as matrix schedulers, generally manage dependencies and resources via a static structure that may not efficiently scale with increasing instruction volume or complexity.

In contrast, the present disclosure generally describes a novel approach to instruction scheduling that overcomes the limitations of conventional schedulers by implementing a dynamic, threshold-based scheduling system. Examples of the present disclosure may enhance the performance of a physical processor by managing scheduler entries in a manner that optimizes the cycle time for source dependencies, accommodating larger scheduler sizes without proportionally increasing complexity or reducing operational frequency.

Some implementations can include the categorization of scheduler entries into a set of delayed broadcast scheduler entries based on a detection of source dependence cycle times that exceed a defined threshold (e.g., at least one cycle). This delayed set is managed separately from the standard scheduling process to mitigate the most challenging timing paths. By pre-picking from this delayed set and integrating these pre-picked entries into the standard pick process, examples of the present disclosure can enable the scheduling of additional instructions beyond the traditional capacity limits imposed by conventional pick-wake constraints.

Moreover, implementations of the present disclosure can include a hybridized pick-wake scheme that can facilitate increased scheduler entry volume without necessitating a corresponding increase in the pick width, thereby enabling the microprocessor to manage a larger number of instructions without a loss in performance. Implementations of the apparatuses, systems, and methods disclosed herein can allow for the delaying of broadcasts to this extended set of scheduler entries, thus maintaining the integrity of the single-cycle operation path while leveraging the benefits of a two-cycle pick-wake scheme.

With an eye toward future-proofing and adaptability, the implementations of the present disclosure can also enable dynamic adjustment of the threshold based on real-time operating conditions of the processor, such as thermal conditions, power consumption, processor utilization, and clock frequency. This responsive design ensures that the scheduling system remains optimal across various operational states.

Hence, examples and implementations of the present disclosure not only address the existing challenges faced by current scheduling mechanisms in microprocessors but also provide a scalable, efficient, and adaptable solution that can be implemented in modern high-performance computing environments.

In some examples, a “source dependence cycle time” can refer to a number of clock cycles required for a scheduled operation or instruction to become ready for execution, taking into account the completion of all its source or prerequisite operations. It can represent time taken between when an operation or instruction is scheduled and when it becomes ready to be picked for execution, contingent on the completion of its source operations.

In some examples, a “broadcast” can refer to an act of updating or communicating a status of instruction execution across different parts of a processor. This might include information such as whether an instruction has been executed, if it's ready to be executed, if it's waiting on data from another instruction, or any other relevant status updates.

In some examples, a scheduler circuit, included in a physical processor, can be configured to pre-pick, from a set of delayed broadcast scheduler entries, a pre-picked set of scheduler entries that have each met a threshold cycle time. The scheduler circuit can pick for execution, from a set of ready scheduler entries, a picked ready scheduler entry that has met a source dependence cycle time. The set of ready scheduler entries can include (1) a set of scheduler entries that have each met the source dependence cycle time, and (2) the pre-picked set of scheduler entries. The scheduler circuit may further delay a broadcast of a scheduler update to the set of delayed broadcast scheduler entries.

In some examples, delaying the broadcast of the scheduler update associated with the picked ready scheduler entry to the set of delayed broadcast scheduler entries includes broadcasting (1) a first scheduler update associated with the picked scheduler entry to a set of scheduler entries managed by the scheduler circuit and excluded from the set of delayed broadcast scheduler entries, and (2) on a delay relative to the broadcast of the first scheduler update, a second scheduler update associated with the picked scheduler entry to a set of scheduler entries managed by the scheduler circuit and included in the set of delayed broadcast scheduler entries.

In some examples, scheduler circuit can be further configured to include the scheduler entry having the source dependence cycle time that exceeds the threshold cycle time in the set of delayed broadcast scheduler entries.

In some examples, the cycle time threshold can be dynamically adjustable based on a current operating condition of the physical processor. In some examples, the current operating condition can include thermal conditions, power consumption, processor utilization, and/or clock frequency.

In some examples, the set of delayed broadcast scheduler entries can include scheduler entries that are not selected for execution during a current cycle to allow resolution of source dependencies.

In some examples, the scheduler circuit may also remove a scheduler entry from the set of delayed broadcast scheduler entries upon determination that its source dependence cycle time falls below the threshold.

In some examples, each scheduler entry can include information regarding source operands, destination operands, operation type, and/or instruction identity.

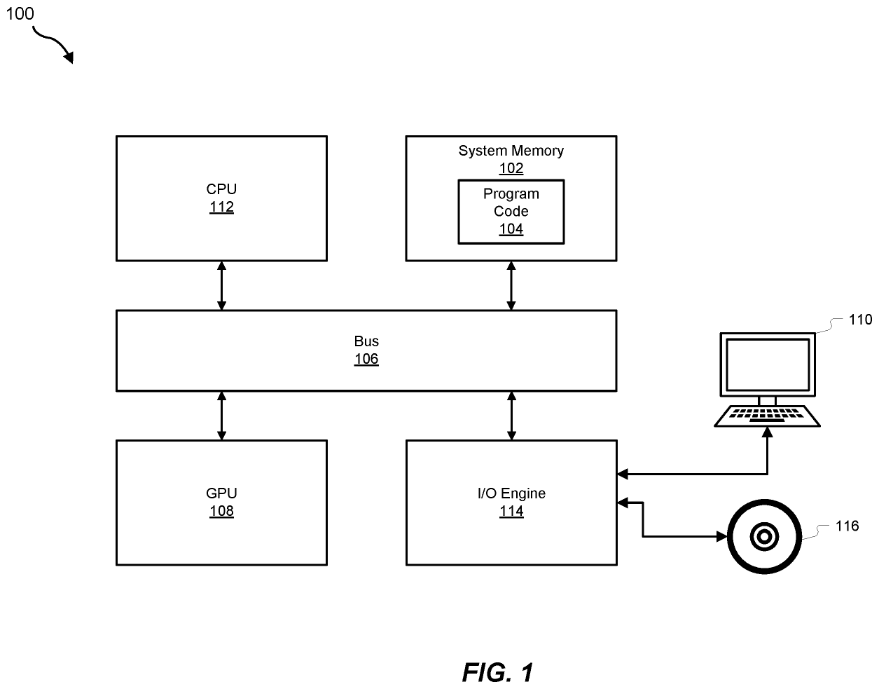

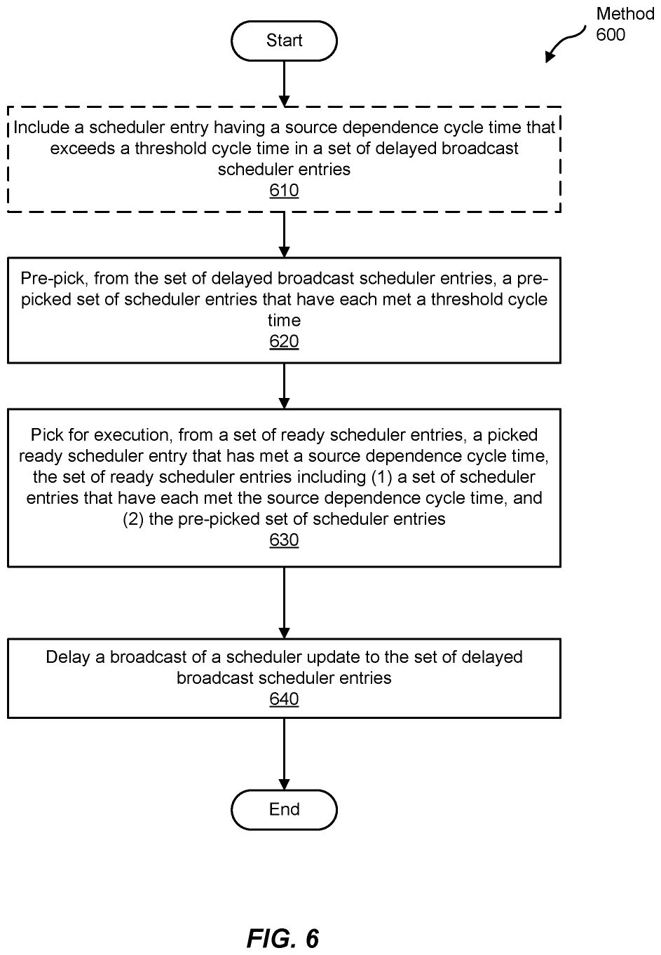

The following will describe, in relation to FIG. 1 to FIG. 7, various different aspects of apparatuses, systems, and methods for scheduling processor operations. FIGS. 1-5 and FIG. 7 provide a series of block diagrams and flow diagrams that detail various aspects of processor operation and management in accordance with implementations of the present disclosure, while FIG. 6 illustrates a flowchart of a method for scheduling processor operations.

FIG. 1 depicts an exemplary block diagram of a processing system 100, according to implementations of the present disclosure. The processing system 100 includes or has access to a system memory 102, implemented using a non-transitory computer-readable medium, such as dynamic random-access memory (DRAM). Additionally, the system memory 102 may also be implemented using other types of memory, including static random-access memory (SRAM), nonvolatile RAM (NVRAM), or spin-torque RAM (STRAM). The system memory 102, being external, is implemented outside the processing units of the processing system 100. Contained within the system memory 102 is program code 104, which comprises instructions executable by the processing system 100 to perform various operations. Furthermore, processing system 100 incorporates a bus 106, facilitating communication between components within the system, such as the system memory 102 and the program code 104.

The processing system 100 is also equipped with a graphics processing unit (GPU) 108, designed to render images for display on a display unit 110. The GPU 108 is tasked with rendering graphical objects, producing pixel values supplied to the display unit 110, which then visualizes the images. Beyond image rendering, the GPU 108 is also capable of general-purpose computing, processing instructions from the program code 104 stored in system memory 102 and storing results back into it.

Processing system 100 also includes a central processing unit (CPU) 112, which connects to the rest of the system via bus 106. The CPU 112 interfaces with both the GPU 108 and system memory 102 through the bus 106, executing stored instructions and managing the data processing. It also plays a role in initiating graphics processing, sending commands to GPU 108 as required.

Additionally, the processing system 100 includes an input/output (I/O) engine 114, managing input and output operations related to various system components, including the display unit 110. The I/O engine 114, connected through bus 106, facilitates interaction with other system components, such as system memory 102, GPU 108, and CPU 112. It manages various peripheral and external device communications and can interact with an external storage device 116, which is implemented as a non-transitory computer-readable medium like a compact disk (CD) or a digital video disc (DVD). The I/O engine 114 can both read from and write to the external storage device 116, enabling data storage and retrieval as part of the processing system's operations.

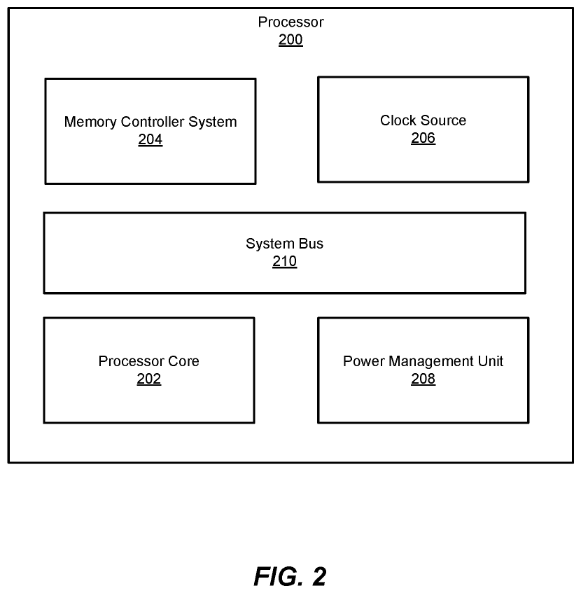

A CPU or GPU (generically, a “processor”) such as GPU 108 and/or CPU 112, may include a number of instances of a core, along with other features. One example of a processor with a single core instance is depicted in FIG. 2. As shown, processor 200 includes one instance of a core, denoted as core 202. Core 202 is coupled to a system bus 210. A memory controller system, labeled as memory controller system 204, is also coupled to system bus 210 and includes off-chip connections to available system memories (e.g., system memory 102). A clock source, denoted as clock source 206, and a power management unit, referred to as PMU 208, are each coupled to core 202.

Core 202 is configured to execute instructions and process data according to a specific Instruction Set Architecture (ISA). In this example, core 202 is designed to implement a particular ISA, although other variations may employ any desired ISA, such as x86, ARM®, PowerPC®, or MIPS®. Furthermore, in this configuration, core 202 is designed to execute multiple threads concurrently, allowing each thread to include a set of instructions that can operate independently from another thread. It is contemplated in various examples that any suitable number of cores may be included within processor 200, and that core 202 may concurrently process a number of threads.

Core 202 may include multiple subsystems for executing various instructions. To support multiple threads, core 202 features additional circuits and buffers for managing each active thread. A sequencing unit in core 202 determines the thread to which each instruction belongs, storing the instruction in the corresponding instruction fetch buffer. In some variations, core 202 may include one or more coprocessors to assist the main execution unit. Examples of suitable coprocessors include floating point units, encryption coprocessors, or digital signal processing engines. Certain subsets of the ISA may be directed towards a coprocessor rather than being executed by the main execution unit.

The memory controller system 204 provides control logic, buffers, and interfaces for accessing memory external to processor 200. The memory controller system 204 may include interfaces for different types of off-chip memory, such as DRAMs, SRAMs, HDDs, SSDs, and more. In various examples, memory controller system 204 may be equipped with circuits for communicating with a variety of memory types.

System bus 210 is configured to manage data flow between core 202 and other components in processor 200, like clock source 206, PMU 208, and others. In one configuration, system bus 210 may include elements such as multiplexers or a switch fabric. Some configurations of system bus 210 may feature logic to queue data requests and responses, preventing requests and responses from hindering other activities while awaiting service. Various types of interconnect networks may be used to implement system bus 210.

Clock source 206 provides clock signals for core 202, offering either consistent or variable frequencies. Clock signal frequencies can be adjusted using local clock divider circuits or by selecting from multiple signals via switches or multiplexors.

PMU 208 controls the distribution of power supply signals within processor 200, adjusting voltage levels to core 202. Voltage levels can be modulated using voltage regulating circuits or selecting from multiple power supply signals. Commands to adjust voltage levels may originate from other components within processor 200, such as core 202 or temperature sensing units.

FIG. 2 illustrates just one configuration of a processor. Other examples of processor 200 might include additional features such as cache memory or network interfaces. While FIG. 2 suggests a logical organization of circuits, physical arrangements may vary, and other components might be included in different configurations of processor 200.

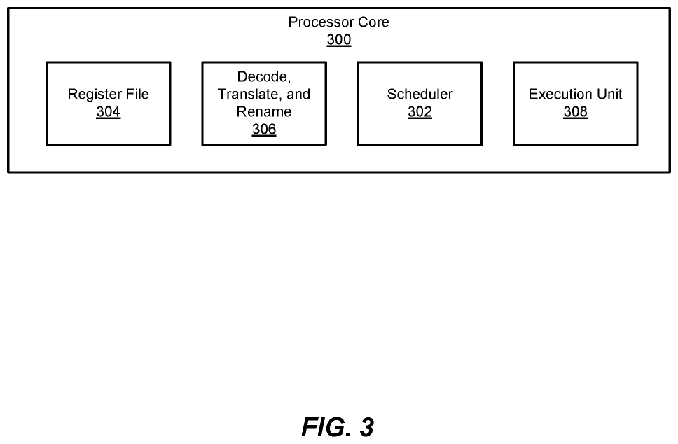

A processor core such as core 202 and/or CPU 112 may include a scheduler. FIG. 3 illustrates a block diagram of an example processor core 300. The processor core 300 includes a scheduler 302, which is responsible for scheduling instructions for execution. The scheduler 302 stores pending instructions until their operands are available in the register file 304. It determines which opcodes are passed to the execution units and in what order, including a scheduler queue and associated issue logic.

In addition, the processor core 300 features a register file 304, used to store instructions, operands used by the instructions, and results of executed instructions. Entries in the register file 304 are indicated by register numbers, which are mapped to architectural register numbers defined by an instruction set architecture. This register file 304 is a circuit structure that may include register sizes suitable for the architecture, such as registers capable of storing wide-bit instructions.

A decode, translate, and rename block 306 receives instructions to be executed by the processor core 300. This decode, translate, and rename block 306 is configured to decode the instructions, perform address translations, and conduct register renaming for instructions as necessary. The decode, translate, and rename block 306 also connects to a retire unit (not shown), which stores instructions until they are retired, thereby updating the state of the processor core 300 with a self-consistent, non-speculative architected state.

The processor core 300 includes an execution unit 308 configured to execute a variety of instructions dispatched from the scheduler 302 and the register file 304. This execution unit 308 processes instructions in multiple stages, including reading, decoding, and executing instructions, followed by writing the results back to the register file 304. Although only one execution unit 308 is shown, variations of the processor core 300 may include multiple execution units to manage different instruction types and concurrent threads.

Processor core 300 may support symmetric multi-threaded features, processing two or more threads simultaneously. This multi-threaded operation requires the scheduler 302 to manage multiple threads effectively, balancing resources and minimizing hazards. The scheduler 302 is designed to select threads that are source-ready and hazard-free, while maintaining fairness in resource allocation among all threads.

It is noted that FIG. 3 represents one configuration of a processor core. Other variations of processor core 300 might include additional components or features, such as cache memory, network interfaces, or specialized coprocessors. The arrangement in FIG. 3 is intended to depict a logical organization of circuits within the processor core, and physical arrangements can vary in different implementations.

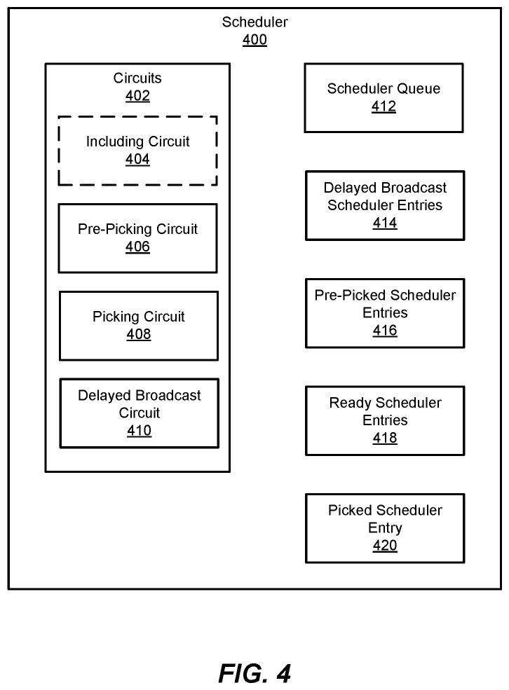

FIG. 4 presents a block diagram of a scheduler circuit 400, designed to optimize the scheduling and execution of instructions in a computing system. This diagram illustrates some of the functional components and their interrelationships within the scheduler circuit 400. As shown, scheduler circuit 400 can include various specialized circuits, collectively represented by circuits 402. These circuits include the (optional, as indicated by dashed lines in FIG. 4) including circuit 404, the pre-picking circuit 406, the picking circuit 408, and the delayed broadcast circuit 410. The scheduler queue 412 serves as an initial repository for incoming scheduler entries before they are processed by the various circuits within the scheduler circuit 400. Once processed, the entries move through the various stages as dictated by their source dependencies and readiness for execution.

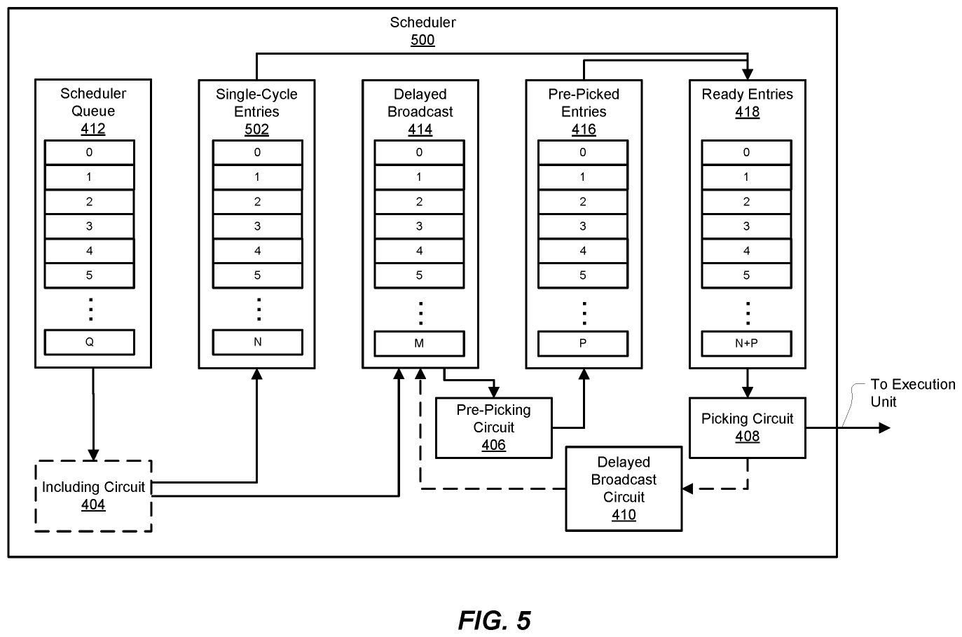

Each of the circuits shown in FIG. 4 and FIG. 5 (e.g., the including circuit 404, the pre-picking circuit 406, the picking circuit 408, and the delayed broadcast circuit 410) represents a distinct function in the process of instruction scheduling and execution. However, this is by way of illustration and not by way of limitation. Indeed, the blocks and/or circuits included in FIG. 4 may illustrate procedures, tasks, and/or processes that may be executed by one or more portions of scheduler circuit 400 to support scheduling of operations within a processor. One or more of these circuits may also represent all or portions of one or more special-purpose electronic devices (i.e., hardware devices) configured to perform one or more tasks. Although illustrated as separate elements, the circuits described and/or illustrated herein may represent portions of a single circuit or portion of a processing unit. One or more of these circuits may also represent all or portions of one or more special-purpose circuits configured to perform one or more tasks.

Furthermore, the collections of scheduler entries depicted in FIG. 4 and FIG. 5, including but not limited to the scheduler queue 412, delayed broadcast scheduler entries 414, pre-picked scheduler entries 416, and ready scheduler entries 418, represent various stages and categories of instruction processing within the scheduler circuit 400. However, it is important to note that these representations are illustrative and not intended to be limiting in any manner. In fact, these collections may encompass a range of functional groupings or classifications of instructions based on their processing status, operational requirements, or scheduling priorities within a processor.

Each collection, such as the scheduler queue 412 or the delayed broadcast scheduler entries 414, is described for convenience of explanation and illustration. These collections can embody diverse forms of data structures, storage mechanisms, or organizational methodologies, which are used for managing and coordinating the flow of instructions through the scheduler circuit. While depicted as distinct entities, these collections might overlap, interconnect, or even be integrated in certain implementations, depending on the specific design and operational needs of the processor.

Furthermore, these collections may not solely represent physical storage locations but could also symbolize logical groupings or software-managed lists of instructions. This allows for flexibility in implementation, enabling the scheduler circuit to adapt to various hardware configurations, processing capabilities, or software algorithms. For instance, the scheduler queue 412 or the pre-picked scheduler entries 416 might be realized through software routines in some variations of the system.

Additionally, the processing tasks associated with these collections of scheduler entries, such as categorizing, updating, or moving instructions between different collections, may be executed by one or more portions of the scheduler circuit 400. This includes the possibility of a single circuit or processor unit managing multiple functions related to different collections, thereby emphasizing the functional aspect over the physical structure.

In summary, the various collections of scheduler entries in FIG. 4 and FIG. 5 should be interpreted broadly to encompass a variety of functional groupings and operational mechanisms within the scheduler circuit. The appended claims are not limited in scope to the specific variations depicted but extend to include various possible implementations that achieve the desired instruction scheduling and processing functionality.

In some examples, a scheduler entry or instruction can include a discrete unit of data within the instruction scheduler that contains information regarding the processing and execution of instructions by a processor. Each scheduler entry can include various elements including, without limitation, source operands, destination operands, an operation type, an instruction identity, and so forth.

Source operands may include data inputs or references to data inputs required by an instruction for execution. Source operands can be values stored in registers, memory locations, or immediate values encoded within the instruction itself. They can provide input data that an instruction needs to perform its designated operation.

Destination operands can refer to locations, such as specific registers or memory addresses, where the results of executing an instruction are stored. Destination operands indicate where the output of an instruction's operation is to be placed within the system, ensuring that the results are accessible for subsequent operations or for delivering the final output of a process.

Operation types can specify a nature or category of the operation to be performed by the instruction. The operation type could include arithmetic operations, logical operations, control flow changes, or any other type of operation defined within the processor's instruction set architecture. It can describe how the source operands will be processed and how the result will be formed.

Instruction identities can be identifiers or references to specific instructions that are to be executed. An instruction identity may encompass the instruction code itself or a pointer/reference to the instruction as stored in the system memory. It uniquely identifies the instruction within the context of the processor's operations, facilitating its retrieval, decoding, and execution.

Hence, a scheduler entry can encapsulate information that an instruction scheduler can use to manage and/or schedule execution of instructions effectively. A scheduler entry can represent a composite view of an instruction, encompassing inputs, outputs, intended action(s), and unique identifier(s), which collectively enable the processor to execute the instruction accurately and efficiently as part of its processing pipeline.

Within the context of scheduler design for microprocessors, there exist two primary constraints that define the limits of design capabilities: the pick width (W) and the single-cycle broadcast width (B). Traditional designs typically equate both pick width (W) and broadcast width (B) to the total number of scheduler entries (Q), as referenced in the scheduler queue 412. However, as Q is expanded to enhance processing capabilities, adherence to design constraints becomes increasingly challenging.

The apparatuses, systems, and methods disclosed herein present a novel approach to overcome these constraints by partitioning Q into two distinct components: N and M, where N represents a number of single-cycle entries in Q and M represents a number of entries in Q that exceed a threshold (e.g., one cycle), and therefore can receive delayed broadcast.

Returning to FIG. 4, optional including circuit 404 is primarily responsible for assessing whether the source dependence cycle time of a scheduler entry managed by the scheduler circuit exceeds a threshold cycle time, which could include a cycle threshold of at least one cycle. This assessment focuses on the duration an entry must wait for the availability of all its source operands. When the cycle time of an entry exceeds this threshold, indicating a need for additional processing, the including circuit 404 incorporates it into the set of delayed broadcast scheduler entries 414. These entries generally comprise those scheduler entries that, due to their extended source dependence cycle times, require more time to resolve their source dependencies, as they form part of the M entries in the total scheduler entries Q=N+M.

In further detail, the concepts of Pick Width (W) and Broadcast Width (B) are integral to understanding the scheduler circuit's functionality. Pick Width (W), defined as N+P, represents the total number of entries that the picking circuit 408 can select for execution at any given time. This is a crucial measure as it directly impacts the processor's ability to handle a diverse range of instructions efficiently. The novel approach of partitioning total scheduler entries (Q) into N and M allows for an optimized pick width. By adjusting the values of N, M, and the pre-picking circuit width (Y), the system can maintain a desired pick width W, even as the total number of scheduler entries (Q) increases. This adaptability ensures that the scheduler can accommodate a growing number of instructions without proportionally increasing the complexity of the pick process.

Broadcast Width (B), on the other hand, is primarily controlled by the picking circuit 408 and is confined to the number of single-cycle entries (N). This design aspect is particularly innovative as it decouples the broadcast width from the growth of M, the set of delayed broadcast scheduler entries. Consequently, as M increases, adding more entries into the delayed broadcast set, the broadcast width B remains unaffected. This separation allows for an increase in the number of scheduler entries Q without a corresponding increase in the single-cycle broadcast width, thereby enhancing the scalability of the scheduler circuit.

The pre-picking circuit 406 makes decisions based on a variety of processor operational characteristics, such as the type of instruction, its priority within the system, the latency associated with the instruction, and the availability of execution units. This nuanced approach allows the pre-picking circuit to make informed decisions about which delayed broadcast entries are nearing readiness for execution. For instance, instructions with higher priority or shorter latency might be pre-picked earlier to optimize the processor's performance. Similarly, the availability of execution units is a critical factor in determining which instructions are moved into the ready set, ensuring that the processor's resources are utilized effectively. This dynamic and responsive mechanism of the pre-picking circuit significantly contributes to the overall efficiency and adaptability of the scheduling process within the processor.

The pre-picking circuit 406 selects entries from the delayed broadcast scheduler entries 414, focusing on those nearing the resolution of their source dependencies. It “pre-picks” these entries, thereby forming the pre-picked scheduler entries 416. This pre-selection process is integral to preparing the entries for imminent execution, aligning with the method's objective to optimize scheduling. The entries are “pre-picked” by the pre-picking circuit 406 prior to being “picked” for execution by the picking circuit 408. This operation is influenced by a pre-picking circuit width (Y), where the number of pre-picked entries (P) is determined by the ratio of M entries in the delayed set to Y, as P equals M/Y, further refining the selection process for execution readiness.

The picking circuit 408 is generally responsible for a final selection of entries for execution. It selects from the set of ready scheduler entries 418, which comprises both the single-cycle scheduler entries, managed by the scheduler circuit and represented by N in the total scheduler entries Q=N+M, and the pre-picked scheduler entries 416. These ready scheduler entries 418 are composed of entries that have satisfied their corresponding source dependence, priming them for immediate execution.

Subsequently, the delayed broadcast circuit 410 is tasked with managing the timing of broadcasting updates to the delayed broadcast scheduler entries 414. When the picking circuit 408 selects an entry for execution, the delayed broadcast circuit 410 disseminates a scheduler update to the entries not included in the delayed broadcast set. This action is crucial for maintaining synchrony within the system and ensuring that the latest execution statuses are accurately communicated. Notably, the broadcast width, driven by the picking circuit 408, is equivalent to the number of single-cycle entries N, allowing the number of scheduler entries Q to grow in M without increasing the single-cycle broadcast width B.

FIG. 5 presents an operational flow block diagram of a scheduler circuit 500 that incorporates various tables representing buffers, queues, and designations that may be included in a processing pipeline in accordance with some implementations. As shown, the scheduler circuit 500 includes many elements of scheduler circuit 400 in FIG. 4, with the addition of single-cycle entries 502, shown with a size of N entries. While groups of scheduler entries are shown as tables in this figure (e.g., scheduler queue 412, delayed broadcast scheduler entries 414, pre-picked scheduler entries 416, ready scheduler entries 418, single-cycle entries 502), this is by way of illustration only, and may not represent any particular configuration of data structures or elements. Indeed, as described herein, scheduler circuit 400 and/or scheduler circuit 500 may operate in a similar fashion to a conventional pick-wake loop, but with the improved and added functionality and features as described herein.

As introduced above, the scheduler queue 412, having a size of Q entries, acts as an initial holding area for instructions waiting to be processed. Including circuit 404 determines a source dependence cycle time for each instruction. Depending on this determination, including circuit 404 includes the instruction in the single-cycle entries 502(N) or the delayed broadcast scheduler entries 414(M). In the case that a scheduler entry or instruction does not exceed the source dependence cycle time threshold, it is not included in the set of delayed broadcast scheduler entries 414.

Scheduler entries not included in the delayed broadcast scheduler entries 414 are managed in other parts of the scheduler circuit. These could include the scheduler queue 412 for entries that are yet to be processed, single-cycle entries 502 for entries ready for execution within a single cycle (i.e., entries with a source dependence cycle time of one cycle or fewer), pre-picked scheduler entries 416 for entries that were initially delayed but are now nearing readiness for execution, and ready scheduler entries 418 for entries that are prepared for immediate execution. the specific holding area for a scheduler entry depends on its current status in the scheduling and execution process.

The single-cycle entries 502 include instructions that can be executed within a single processor cycle (i.e., entries that have met their source dependences and/or will be ready to be executed at the next pick). These entries are included in the ready (or pickable) scheduler entries 420, signifying that they are ready for execution. In contrast, the delayed broadcast scheduler entries 414 include instructions that require more than one cycle to resolve their dependencies. These instructions are subject to further analysis and/or processing by pre-picking circuit 406.

Pre-picking circuit 406, as described in additional detail above, evaluates instructions from the delayed broadcast scheduler entries 414 and selects those that are nearing readiness for execution, forming the pre-picked scheduler entries 416. Pre-picked scheduler entries 416 include instructions that, while perhaps initially delayed, are now nearing execution readiness. These instructions are then included in ready scheduler entries 418, joining the single-cycle entries.

The pre-picking circuit 406 can evaluate and select instructions from the delayed broadcast scheduler entries 414 that are nearing readiness for execution. As instructions are processed by including circuit 404 and identified as requiring delayed processing, including circuit 404 forwards them to delayed broadcast scheduler entries 414. The pre-picking circuit 406 then assesses these instructions to determine which ones have met their respective source dependencies and are approaching a state where they can be executed. This assessment is based on various factors, such as the resolution of dependencies and the readiness of the instructions for the next stages of processing.

Instructions selected by the pre-picking circuit 406 form the pre-picked scheduler entries 416. This set includes those instructions from the delayed broadcast set that are almost ready for execution but were initially delayed due to their longer source dependence cycle times. pre-picked scheduler entries 416 represent a transitional phase for these instructions as they move closer to being executed.

In some examples, pre-picking circuit 406 may scrutinize each scheduler entry included in delayed broadcast scheduler entries 414 and/or any scheduler entry designated for delayed broadcast. The aim is to determine which entries are nearing the readiness state for execution, despite initially requiring additional processing time due to extended source dependence cycle times. The selection criteria used for this evaluation can be pre-defined and may be carefully tailored to align with the specific operational parameters and performance capabilities of the physical processor. This alignment can ensure that the scheduler entries selected for pre-picking are optimally suited for the current operational state and processing demands of the processor.

In some variations, operational characteristics considered in the pre-picking process can encompass several key aspects of the processor's functionality. These characteristics include, but are not limited to, an instruction type, an instruction priority, an instruction latency, and/or an execution unit availability.

Instruction type may refer to a category or nature of the instructions within the scheduler entries. Different instruction types may have varying processing requirements and impacts on the processor's performance. By considering instruction type, the pre-picking circuit 406 can prioritize certain instructions that are more critical or beneficial to the processor's current operational mode.

Some instructions may be assigned a higher priority level based on their importance or urgency in the context of the processor's overall task execution. Pre-picking circuit 406 can take these instruction priority levels into account to ensure that high-priority instructions are processed in a timely manner.

Instruction latency relates to the time taken for an instruction to be executed once it is picked for processing. Instruction latency can affect the processor's efficiency and throughput. By evaluating latency, the pre-picking process can optimize the scheduling of instructions to reduce delays and improve processing speed.

Execution unit availability may refer to the availability of execution units within the processor. Pre-picking circuit 406 can consider which execution units are available at any given time, allowing for smarter scheduling decisions that fully utilize the processor's execution capabilities.

The pre-picking circuit 406 facilitates a more efficient processing flow within the scheduler by preparing instructions in advance of their actual selection for execution. By doing so, it helps to ensure that the processor is able to maintain a steady throughput of instructions, effectively managing those that require more complex processing due to their source dependencies.

By handling instructions that have been delayed but are nearly ready for execution, the pre-picking circuit 406 aids in optimizing the overall scheduling process. This contributes to the processor's ability to manage a diverse range of instructions, enhancing its performance and efficiency.

Ready scheduler entries 418 includes instructions from both single-cycle entries 502 and pre-picked scheduler entries 416 that are prepared for execution. This set feeds into the picking circuit 408, which is responsible for selecting instructions for execution. The picking circuit 408 chooses instructions based on their readiness and other scheduling criteria.

One role of the picking circuit 408 can be to evaluate and choose scheduler entries from the ready scheduler entries 418 for execution. Ready scheduler entries 418 accumulates instructions that are immediately ready for execution and those that have been pre-picked and are nearing execution readiness, and is shown in FIG. 5 as including N+P entries. The picking circuit 408 assesses these instructions based on various criteria such as their readiness, priority, and the overall needs of the processor's operational flow.

Once an instruction is picked by the picking circuit 408 (e.g., picked scheduler entry 420), picking circuit 408 performs two actions. Firstly, it sends the picked instruction to an execution unit of the processor (e.g., execution unit 308), which processes the instruction. This step relates to the actual execution of tasks and operations as dictated by the processor's instruction set. Secondly, the picking circuit 408 communicates with the delayed broadcast circuit 410, which updates the status of instructions not included in delayed broadcast scheduler entries 414. This update helps maintain the coherence and consistency of the instruction flow, particularly for instructions that depend on the outcomes of the currently executed instruction.

In some examples, a scheduler update can include a communication or signal generated by the instruction scheduler following the picking of a scheduler entry for execution. One component of this scheduler update can be a wake directive. The wake directive is a specific instruction or signal within the scheduler update that activates or readies other parts of the processor system for the execution of the picked scheduler entry. Its role is to alert the processor's components, such as execution units or other scheduler entries, that a particular instruction is about to be executed. This can involve preparing necessary resources, adjusting states, or triggering specific actions that are necessary for the smooth execution of the picked instruction. The wake directive essentially “wakes up” any relevant processes or components that need to respond to or be aware of the impending instruction execution. This may include notifying dependent instructions that an operand they have been waiting for will soon be available, or signaling to the execution unit to prepare for the incoming operation.

The delayed broadcast circuit 410 functions by temporarily holding back the broadcasting of status or updates for scheduler entries identified as needing more time to resolve source dependencies, indicated by their inclusion in the delayed broadcast scheduler entries 414. This delay synchronizes the processing flow within the scheduler circuit 400, ensuring all conditions are met before an instruction is marked ready for execution. It also provides cycle time for other circuits in scheduler circuit 500, such as the pre-picking circuit 406, to perform their tasks. Notably, this circuit limits the broadcast width, B, driven by the picking circuit 408 to the number of single-cycle entries N, allowing the number of scheduler entries Q to grow in M without increasing B.

In some instances, the delayed broadcast circuit 410 can remove an entry from the delayed broadcast scheduler entries 414 if it initially exceeded the threshold cycle time but subsequently falls below it. This removal is based on reevaluation or subsequent determination of the source dependence cycle time.

Such reevaluation, possibly continuous or periodic, may be conducted by the including circuit 404 or another component within the scheduler circuits 400 or 500. It monitors the source dependence cycle times of entries within the delayed broadcast scheduler entries 414. When an entry's source dependencies are resolved sooner than expected, reducing its source dependence cycle time below the threshold, it becomes ready for quicker processing. Thus, it's moved from the delayed broadcast scheduler entries 414 to a more immediate processing pathway like the ready scheduler entries 418.

The delayed broadcast circuit 410 also plays a crucial role in managing the instruction flow within the processor, avoiding premature broadcast of execution statuses and potential operational conflicts or inefficiencies. By timing the broadcasting of updates, particularly for entries needing more processing time, the circuit ensures a smooth and efficient instruction progression through the scheduler.

FIG. 6 depicts a flow diagram for method 600, outlining a sequence of operations for scheduling processor activities in accordance with certain examples and/or variations of the present disclosure. The method exemplifies a systematic approach to managing scheduler entries within a scheduler circuit of a physical processor, ensuring that instructions are efficiently processed based on their readiness and source dependencies.

The process begins at optional step 610, indicated in dashed lines, where the method may include incorporating the scheduler entry into a set of delayed broadcast scheduler entries. This may include detecting that the source dependence cycle time of a scheduler entry exceeds a predetermined threshold. These entries included in the set of delayed broadcast scheduler entries are designated for delayed processing due to their longer source dependence cycle times. This step may be performed in any of the ways described herein.

As an illustrative example, an example instruction (part of scheduler queue 412) may require data from two previous instructions to execute. Including circuit 404 may detect that example instruction's source dependence cycle time is three cycles because both of the previous instructions will take three cycles to complete. If the predetermined threshold is two cycles, including circuit 404 may flag the example instruction in this step because its source dependence cycle time exceeds the threshold.

The example instruction with a source dependence cycle time of three cycles is then added to the delayed broadcast scheduler entries 414 (e.g., by including circuit 404). This collection is a holding area for instructions that require more than the predetermined threshold of cycles to become ready for execution due to source dependencies.

Moving to step 620, pre-picking is performed on the set of delayed broadcast scheduler entries. Here, a pre-picked set of scheduler entries is assembled from those that have now met the threshold cycle time, indicating they are approaching readiness for execution. This step may be performed in any of the ways described herein.

Continuing from the previous example, as the processor continues to operate, pre-picking circuit 406 constantly checks the delayed broadcast scheduler entries 414. When it identifies that our example instruction's source dependencies are nearing resolution (i.e., the previous instructions are about to complete), pre-picking circuit 406 “pre-picks” this instruction (i.e., “moves” it to pre-picked scheduler entries 416). This means the example instruction is flagged as nearly ready for execution.

Step 630 describes the selection process for execution, where a picked scheduler entry from a set of ready scheduler entries is chosen. The set of ready scheduler entries includes a set of scheduler entries having a source dependence cycle time of less than the threshold cycle time, along with the pre-picked set of scheduler entries (i.e., the pre-picked scheduler entries that were previously included in the set of delayed broadcast scheduler entries). This step may be performed in any of the ways described herein.

Returning to the above example, once all source dependencies for the example instruction are resolved, pre-picking circuit 406 moves the example instruction from pre-picked scheduler entries 416 to ready scheduler entries 418. From here, the picking circuit 408 selects the instruction for execution based on its readiness and other scheduling criteria.

Step 640 involves delaying the broadcast to the set of delayed broadcast scheduler entries. This delay is affected by broadcasting a first scheduler update, associated with the picked scheduler entry, to a set of scheduler entries that are not part of the delayed broadcast set. Then, on a delay (e.g., one or more cycles) relative to the broadcast of the first scheduler update, a second a second scheduler update to the set of delayed broadcast scheduler entries. This step may be performed in any of the ways described herein.

After our example instruction is picked for execution, the picking circuit 408 communicates with the delayed broadcast circuit 410. The delayed broadcast circuit 410 then updates all other entries in the delayed broadcast scheduler entries 414 on a delay relative to a broadcasted update to all other instructions in the scheduler 500 (e.g., an update broadcasted by picking circuit 408 and/or an execution unit that executes the example instruction, such as execution unit 308). This update helps maintain coherence within the system and ensures that the latest execution statuses are accurately communicated.

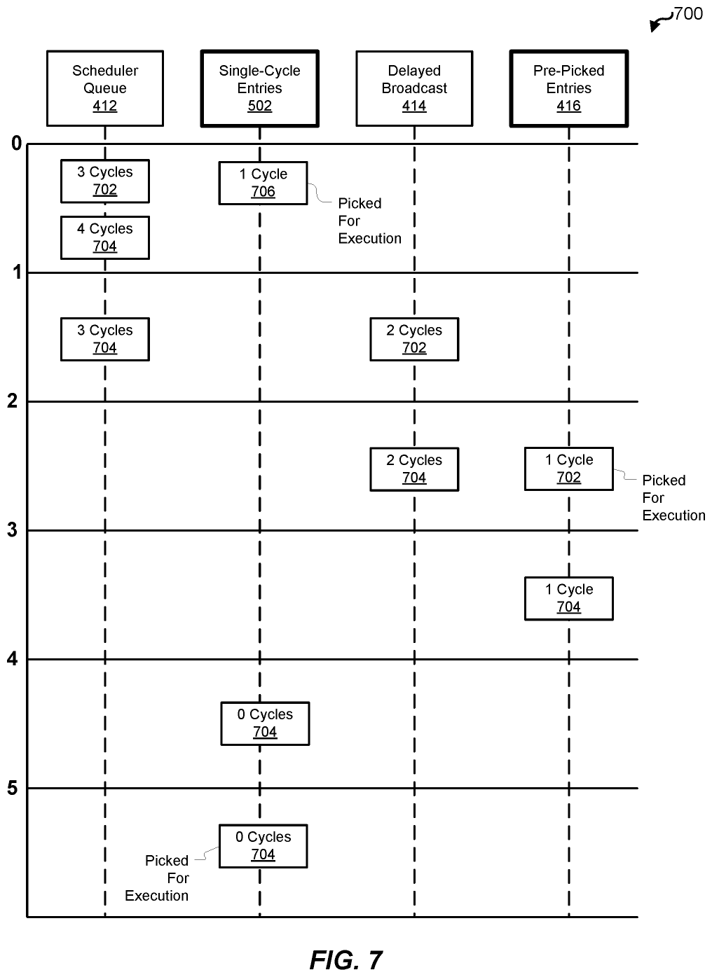

FIG. 7 is a state transition diagram 700 that illustrates how scheduler entries may transition through various components of a scheduler circuit over multiple cycles. The diagram involves three scheduler entries: scheduler entry 702 starting with a source dependence cycle time of 3 cycles, scheduler entry 704 starting with a source dependence cycle time of 4 cycles, and scheduler entry 706 starting with a source dependence cycle time of 1 cycle. In this example, the source dependence cycle time threshold is 2 cycles.

At the start, scheduler entry 702 and scheduler entry 704 are in the scheduler queue 412, an initial holding area for instructions awaiting processing. Scheduler entry 706 is in single cycle entries 502. After the first cycle, scheduler entry 702, now with 2 cycles remaining, is moved to the delayed broadcast scheduler entries 414, while scheduler entry 704, with 3 cycles remaining, stays in the scheduler queue 412. Scheduler entry 702 is picked for execution and leaves scheduler 500.

After the second cycle, scheduler entry 702, now with 1 cycle remaining, has moved from the delayed broadcast scheduler entries 414 to the pre-picked scheduler entries 416, signifying that it is nearing readiness for execution. Meanwhile, scheduler entry 704, now with 2 cycles remaining, has been moved to the delayed broadcast scheduler entries 414.

After the third cycle, scheduler entry 702, picked for execution, has exited scheduler 500. Scheduler entry 704, now with 1 cycle remaining, has moved from the delayed broadcast scheduler entries 414 to the pre-picked scheduler entries 416 as it nears execution readiness.

After the fourth cycle, scheduler entry 704, not yet picked for execution, has moved from the pre-picked scheduler entries 416 to the single cycle entries 502 which, as noted above, includes entries having source dependence cycle times of one cycle or fewer. Alternatively, though not shown in FIG. 7, in some implementations, scheduler entry 704 may remain within pre-picked scheduler entries 416 until picked for execution, as both pre-picked scheduler entries 416 and single-cycle entries 502 are included as part of ready scheduler entries 418, and picking circuit 408 picks from ready scheduler entries 418. Additionally, although another scheduler entry is not shown in this figure, and although scheduler entry 704 may be ready for execution, picking circuit may pick another scheduler entry for execution.

After the fifth cycle, scheduler entry 704 is ready for execution in the single cycle entries 502 and is picked for execution by the picking circuit 408.

As described above in relation to FIG. 5, scheduler entries included in single cycle entries 502 and pre-picked entries 416 are considered ready for selection, and thus may be conceptually included in ready scheduler entries 418. This detailed depiction of FIG. 7 provides insight into the transitions an instruction undergoes in the scheduling process within the scheduler circuit 500, after each cycle has occurred. It illustrates the roles of the scheduler queue 412, delayed broadcast scheduler entries 414, pre-picked scheduler entries 416, and single cycle entries 502 in managing instructions based on their source dependence cycle times and readiness for execution.

As may be clear from the foregoing description, the apparatuses, systems, and methods disclosed herein have many benefits over conventional options for scheduling processor operations. They introduce an advanced scheduling framework that enhances the performance and efficiency of processors by dynamically managing instruction flow based on the readiness of scheduler entries. Central to these benefits is the ability of the system to enable a wider scheduler. By effectively categorizing instructions into sets of delayed broadcast and ready scheduler entries, and further refining the process through pre-picking operations, the system expands the capacity of the scheduler. This expanded capacity allows for a greater number of instructions to be processed within the same cycle time, thus enhancing the throughput of the processor.

In other words, by delaying a broadcast of a status update to scheduler entries that will not be ready for execution on the next cycle, scheduler 500 can use the time saved by this delayed broadcast to “pre-pick” from the delayed broadcast entries that have become ready since the last broadcasted update. This effectively expands the width W of the scheduler to the single cycle entries 502(N) and the pre-picked entries 418(P). Thus, the “width” that the scheduler can “pick across” to select a scheduler entry for execution conceptually increases from W to N+P.

A unique aspect of this disclosure may be that the delay in broadcasts can be specifically applied to single-cycle operations. Essentially, the dependency of the single-cycle loop on additional entries is being severed, while simultaneously ensuring that operations dependent on longer-than-single-cycle operations are not delayed. Hence, the disclosed systems and methods may represent a hybrid approach that combines a single-cycle pick-wake scheme with a two-cycle pick-wake scheme, while still considering that multi-cycle operations will broadcast according to their inherent latency.

Furthermore, the delayed broadcast mechanism ensures that instructions are only flagged as ready to execute when all conditions are truly met. This feature can prevent execution conflicts and resource contention, common challenges in conventional systems. The intelligent broadcasting of scheduler updates aligns the execution of instructions with the actual availability of processor resources, resulting in a more streamlined and coherent scheduling process.

The described apparatuses, systems, and methods also adapt to the operational characteristics of the processor, such as instruction type, priority, latency, and execution unit availability. This adaptability ensures that the scheduling process is not just generic but customized to the processor's current state and workload, thereby optimizing performance.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a product in a variety of forms, regardless of the particular type of processor or computer-readable media used to actually conduct the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a physical processor;
a scheduler circuit, included in the physical processor, configured to:
pre-pick, from a set of delayed broadcast scheduler entries, a pre-picked set of scheduler entries that have each met a threshold cycle time;
pick for execution, from a set of ready scheduler entries, a picked ready scheduler entry that has met a source dependence cycle time, the set of ready scheduler entries comprising:
a set of scheduler entries that have each met the source dependence cycle time; and
the pre-picked set of scheduler entries; and
delay a broadcast of a scheduler update to the set of delayed broadcast scheduler entries.

2. The system of claim 1, wherein delaying the broadcast of the scheduler update associated with the picked ready scheduler entry to the set of delayed broadcast scheduler entries comprises broadcasting:
a first scheduler update associated with the picked scheduler entry to a set of scheduler entries managed by the scheduler circuit and excluded from the set of delayed broadcast scheduler entries; and
on a delay relative to the broadcast of the first scheduler update, a second scheduler update associated with the picked scheduler entry to a set of scheduler entries managed by the scheduler circuit and included in the set of delayed broadcast scheduler entries.

3. The system of claim 1, wherein the scheduler circuit is further configured to include the scheduler entry having the source dependence cycle time that exceeds the threshold cycle time in the set of delayed broadcast scheduler entries.

4. The system of claim 1, wherein the cycle time threshold is dynamically adjustable based on a current operating condition of the physical processor.

5. The system of claim 4, wherein the current operating condition includes at least one of:
thermal conditions;
power consumption;
processor utilization; or
clock frequency.

6. The system of claim 1, wherein the set of delayed broadcast scheduler entries comprises scheduler entries that are not selected for execution during a current cycle to allow resolution of source dependencies.

7. The system of claim 1, further comprising removing a scheduler entry from the set of delayed broadcast scheduler entries upon determination that its source dependence cycle time falls below the threshold.

8. The system of claim 1, wherein each scheduler entry comprises information regarding one or more of:
source operands;
destination operands;
operation type; or
instruction identity.

9. A scheduler circuit comprising:
a pre-pick circuit that pre-picks, from a set of delayed broadcast scheduler entries, a pre-picked set of scheduler entries that have each met a threshold cycle time;
a picking circuit that picks for execution, from a set of ready scheduler entries, a picked scheduler entry that has met a source dependence cycle time, the set of ready scheduler entries comprising:
a set of scheduler entries that have each met the source dependence cycle time; and
the pre-picked set of scheduler entries; and
a delayed broadcast circuit that delays a broadcast of a scheduler update to the set of delayed broadcast scheduler entries.

10. The scheduler circuit of claim 9, wherein the delayed broadcast circuit delays the broadcast of the scheduler update associated with the picked ready scheduler entry to the set of delayed broadcast scheduler entries by broadcasting:
a first scheduler update associated with the picked scheduler entry to a set of scheduler entries managed by the scheduler circuit and excluded from the set of delayed broadcast scheduler entries; and
on a delay relative to the broadcast of the first scheduler update, a second scheduler update associated with the picked scheduler entry to a set of scheduler entries managed by the scheduler circuit and included in the set of delayed broadcast scheduler entries.

11. The scheduler circuit of claim 9, further comprising an including circuit that includes the scheduler entry having the source dependence cycle time that exceeds the threshold cycle time in the set of delayed broadcast scheduler entries.

12. The scheduler circuit of claim 9, wherein the threshold cycle time is dynamically adjustable based on a current operating condition of a physical processor that includes the scheduler circuit.

13. The scheduler circuit of claim 12, wherein the current operating condition includes at least one of:
thermal conditions;
power consumption;
processor utilization; or
clock frequency.

14. The scheduler circuit of claim 9, wherein the set of delayed broadcast scheduler entries comprises scheduler entries that are not selected for execution during a current cycle to allow resolution of source dependencies.

15. The scheduler circuit of claim 9, further comprising removing a scheduler entry from the set of delayed broadcast scheduler entries upon determination that its source dependence cycle time falls below the threshold.

16. The scheduler circuit of claim 9, wherein each scheduler entry comprises information regarding one or more of:
source operands;
destination operands;
operation type; or
instruction identity.

17. A method comprising:
pre-picking, from a set of delayed broadcast scheduler entries, a pre-picked set of scheduler entries that have each met a threshold cycle time;
picking for execution, from a set of ready scheduler entries, a picked scheduler entry that has met a source dependence cycle time, the set of ready scheduler entries comprising:
a set of scheduler entries that have each met the source dependence cycle time; and
the pre-picked set of scheduler entries; and
delaying a broadcast of a scheduler update to the set of delayed broadcast scheduler entries.

18. The method of claim 17, wherein pre-picking comprises evaluating each scheduler entry in the set of delayed broadcast scheduler entries against a pre-defined selection criteria based on operational characteristics of a physical processor.

19. The method of claim 18, wherein the operational characteristics comprise at least one of:
an instruction type;
an instruction priority;
an instruction latency; or
an execution unit availability.

20. The method of claim 19, wherein detecting that the source dependence cycle time of the scheduler entry exceeds a threshold cycle time comprises monitoring a dependency matrix within a scheduler circuit within the physical processor.
